(19) United States
(12) Patent Application Publication
(10) Pub. No.: US 2015/0207366 A1
(43) Pub. Date: Jul. 23, 2015

(54) Annular stack of laminations comprised of single-tooth stacks and method for manufacturing a stack of lamination

(71) Applicant: Kienle + Spiess GmbH, Sachsenheim (DE)

(72) Inventor: Georg Burkhardt, Vaihingen/Enz (DE)

(21) Appl. No.: 14/598,372

(22) Filed: Jan. 16, 2015

(30) Foreign Application Priority Data
Jan. 17, 2014 (DE) 10 2014 000 690.5

(51) Int. Cl. H02K 1/06; B32B 37/12; B32B 38/00; H02K 15/02; B32B 37/18

(52) U.S. Cl. CPC H02K 1/06; H02K 15/02; B32B 37/18; B32B 38/0004; B32B 37/1292; H02K 2201/09; B32B 2457/00

(57) ABSTRACT

The annular stack of laminations provides adjoined single-tooth stacks, each exhibiting a pole body and a pole shoe. Adjacent single-tooth stacks abut against each other with the faces of their pole shoes. Adjacent single-tooth stacks are joined together by at least one adhesive bond in such a way that the adhesive bond can be dissolved by applying a force so as to detach the single-tooth stacks from the annular stack of laminations. While manufacturing the stack of laminations, an adhesive is at least partially introduced between the single-tooth stacks. The single-tooth stacks can be detached from the annular stack of laminations by the user for coating and winding purposes. The adhesive bond ensures that the single-tooth stacks are reliably held together during transport.

### BACKGROUND OF THE INVENTION

The invention relates to an annular stack of lamination consisting of adjoined single-tooth stacks, which each exhibit at least one pole body and at least one pole shoe, wherein adjacent single-tooth stacks abut each other with the faces of their pole shoes. The invention further relates to a method for manufacturing such a stack of lamination, in particular of the aforementioned kind, in which single-tooth stacks are joined with the faces of the pole shoes adjoining each other.

Known in the art is to put together single-tooth stacks composed of single-tooth laminations into an annular stack of laminations. In order to be able to put the single-tooth stacks together into an annular stack of laminations, the pole shoes of the single-tooth stacks exhibit defined contact surfaces, preferably a projection on their one face and a depression complementary thereto on their opposing face. The projection is shaped like a pitch circle, and extends over more than 180°. While being joined together, the single-tooth stacks with their projection at one end of the single-tooth stack are inserted into the corresponding depression of the adjacent single-tooth stack, and displaced in the longitudinal direction of the single-tooth stack until such time as the joined single-tooth stacks are at the same height. The joined single-tooth stacks are taken apart again at the customer, so as to coat and wind them. The single-tooth stacks are then again put together into the annular stack of laminations. In both the joining and separating process, undesirable deformations often arise in the area of the projections and depressions, which worsens the electrical properties of the stack of laminations as well as the geometric conditions. It is possible that chips get into the depressions while pushing together the single-tooth stacks. The chips come from the punch burr that forms on the single-tooth laminations while being punched out of a metal strip. The chips can lead to a short circuit when using the stack of laminations in electrical equipment.

The object of the invention is to design the generic annular stack of laminations as well as the generic method in such a way that the single-tooth stacks can be easily put together into an annular stack of laminations and also detached from the latter, without adverse effect of the electrical and geometric conditions and having to fear short circuits during the later use of the stack of laminations.

### SUMMARY OF THE INVENTION

According to the invention, this object is solved for the annular stack of laminations of the aforementioned kind in that adjacent single-tooth stacks are joined together by at least one adhesive bond in such a way that the adhesive bond can be released by applying a force so as to detach the single-tooth stacks from the annular stack of laminations. According to the invention, the object is solved for the method of the aforementioned kind in that an adhesive is at least partially introduced between the single-tooth stacks.

The annular stack of laminations consists of individual single-tooth stacks, wherein adjacent single-tooth stacks are joined together via at least one adhesive bond. The adhesive bond is designed in such a way that it can be released by applying comparatively little force. It is possible to release this adhesive bond with corresponding manual force, so that the single-tooth stacks can be detached from the annular stack of laminations by the user for coating and winding purposes. The adhesive bond is here configured in such a way as to reliably hold the single-tooth stacks together during transport.

In a simple embodiment, the single-tooth stacks abut flat against each other with the faces of their pole shoes, and are held together by the adhesive bond.

However, it is advantageous if the one face of the pole shoes exhibits at least one projection, and the other face exhibits at least one depression, which are each preferably free of undercuts in design. The projections and depressions make it easier to put together the individual single-tooth stacks in an accurately positioned manner after they have been coated and wound into the annular stack of laminations.

Due to the preferred undercut-free design, the single-tooth stacks comprised of the single-tooth laminations can be very easily put together by plugging the projection of one single-tooth stack laterally into the depression of the adjacent single-tooth stack of laminations. As a result, adjacent single-tooth stacks do not have to be longitudinally shifted. It is correspondingly simple to again detach the single-tooth stacks from each other. The undercut-free design of the projection and depression prevent undesired plastic deformations from arising in the separating and joining process. This also eliminates the danger of punch burs braking off and getting into the depressions in the separating and joining process. The inventive configuration of the single-tooth laminations makes it possible to fabricate single-tooth stacks, and hence annular stacks of laminations, which are characterized by outstanding electrical and/or geometric properties, since the single-tooth laminations adjacent to each other in the punching process are also adjacent to each other in the assembled, annular stack of laminations.

The projection and depression are preferably designed complementary to each other, thereby ensuring a simple joining process and precise alignment of the single-tooth stacks relative to each other.

It helps to precisely position the single-tooth stacks, if the width of the projection in the area of the face of the pole shoe is smaller than the width of this face. In this case, adjacent single-tooth stacks abut against each other not just with the projections and depressions, but rather also with the faces of the pole shoes in the area outside the projections and depressions.

In an advantageous embodiment, the projection of the single-tooth lamination is designed in such a way that, starting from the face of the pole shoe, its width tapers in the direction toward its free end.

The single-tooth lamination can here be easily fabricated if the projection continuously tapers from the face of the pole shoe in the direction toward its free end. Projections shaped in this way are easy and cost-effective to manufacture. In this way, single-tooth stacks composed of such single-tooth laminations can also be more easily separated from each other and joined together.

In an advantageous embodiment, the projection exhibits a triangular contour.

In another advantageous embodiment, the projection can also exhibit approximately semicircular contour.

A reliable connection between adjacent single-tooth stacks is obtained if the adhesive is located in the area of the joint gap between adjacent single-tooth stacks. The adhesive can here be provided between the external side of the projection and the wall of the depression. It is also possible for the adhesive to be present solely or additionally hereto also in the area of the abutting faces outside the projection or depression.

A sufficiently strong and yet easily dissolvable adhesive bond is obtained by applying the adhesive in the form of glue dots. Only as many glue dots as necessary to yield the desired strong connection between the single-tooth stacks have to be applied. This type of design also saves on adhesive.

The adhesive is applied in the area of the joint gaps between adjacent single-tooth stacks. The adhesive is here advantageously applied in the area of the joint gaps to at least one face of the stack of laminations. A capillary effect then causes the adhesive to penetrate into the joint gap. Applying the adhesive to both faces of the stack of laminations in the area of the joint gaps yields an even better adhesive bond between adjacent single-tooth stacks.

The adhesive can also be applied to the joint gap between adjacent single-tooth stacks along the single-tooth stack at spaced apart locations. A capillary effect causes the adhesive to penetrate into the respective joint gap.

It is further advantageous to apply the adhesive not over the entire surface, but rather in the form of drops. This is sufficient for achieving a liable bond between the single-tooth stacks. They can here be manually detached from each other again by expending the appropriate force.

The separating sites are advantageously first fabricated between adjacent single-tooth laminations in a punching tool. In a further step, the single-tooth laminations are advantageously punched out using the same punching tool. They are annularly arranged.

In order to form the stack of laminations, the single-tooth laminations annularly arranged one behind the other are placed on top of each other and joined together in a suitable manner. In this way, the single-tooth laminations lying one atop the other can be welded together and/or adhesively bonded with each other and/or positively and/or non-positively connected with each other.

The adhesive is advantageously also applied to faces of single-tooth laminations inside the stack of laminations.

The object of this application is not only defined by the subject matter of the individual claims, but also by all information and characteristics disclosed in the drawings and the description. Even if they are not subject matter of the claims, these characteristics are claimed as essential to the invention as far as they are novel in comparison with the prior art individually or in combination.

Additional features of the invention result from the additional claims, the specification and the drawings.

### BRIEF DESCRIPTION OF THE DRAWINGS

The invention will be explained in greater detail based on several embodiments depicted in the drawings.

FIG. 1 is a perspective view of an annular stack of laminations composed of single-tooth laminations according to the invention.

FIG. 2 is a side view of the stack of laminations.

FIG. 3 is a top view of the stack of laminations.

FIG. 4 is a magnified view of the detail A of FIG. 3.

FIG. 5 is another embodiment of a stack of laminations composed of single-tooth laminations according to the invention in a depiction according to FIG. 3.

FIG. 6 shows a detail view of the stack of laminations of FIG. 5 in a depiction according to FIG. 4.

FIG. 7 is another embodiment of a stack of laminations composed of single-tooth laminations according to the invention in depiction according to FIG. 3.

FIG. 8 shows a detail view of the stack of laminations of FIG. 7 in a depiction according to FIG. 4.

### DESCRIPTION OF PREFERRED EMBODIMENTS

The laminations in the form of single teeth described below are used to form annular stack of laminations, which are used in electrical machines. For example, such stacks of laminations are used in the rotors and/or stators of electric motors.

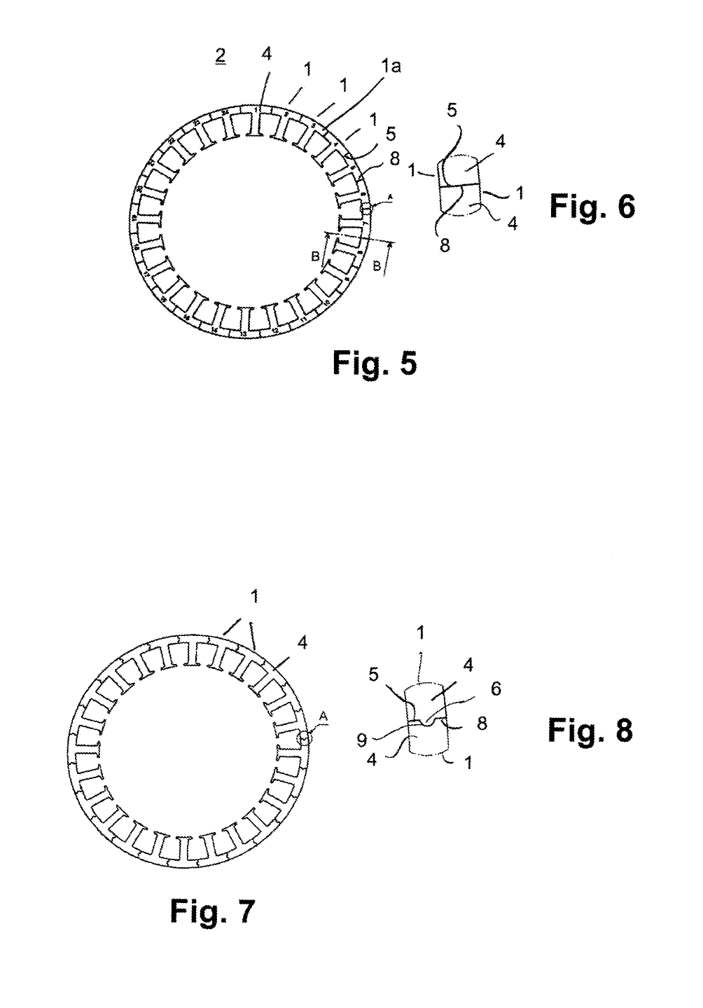

The laminations described below are single teeth which form a ring. The punched rings are subsequently assembled into an annular stack of laminations 2. It consists of abutting single-tooth stacks 1. As exemplarily indicated on FIG. 5, they are consecutively numbered. In the depicted exemplary embodiment according to FIG. 5, the annular stack of laminations 2 consists of 24 single-tooth stacks 1. The single-tooth stacks 1 are assembled into the annular stack of laminations 2 for transport to the customer. The customer divides the annular stack of laminations 2 into the single-tooth stacks 1, so as to coat and wind the latter. The single-tooth stacks 1 are then joined back together again in the previous sequence to yield the stack of laminations 2. The single-tooth stacks 1 are designed in such a way that they can be readily detached from each other for further processing, and then easily put back together into the annular stack of laminations 2. The numeration of the single-tooth stack 1 is intended to illustrate that the laminations adjacent during the punching process are also adjacent in the stack of laminations 2 after the single-tooth stacks 1 have been taken apart and put together. This yields optimal geometric and electrical properties for the stack of laminations 2.

The single-tooth stacks 1 are composed of single-tooth laminations 1a. The single-tooth laminations 1a are advantageously fabricated out of a metal strip, from which single laminations 1a are cut out, as exemplarily depicted on FIG. 5. They can here be cut out of the metal strip by way of punching, but also in other cutting procedures, for example laser cutting.

The single-tooth lamination 1a has a pole body 3 and a pole shoe 4. The pole body 3 and pole shoe 4 can be designed as a single piece with each other. However, it is also possible to fabricate the pole body 3 and pole shoe 4 separately from each other, and join them together later.

The first face 5 of the pole shoe 4 is provided with a projection 6, which has approximately a triangular contour. The tip 7 of the projection 6 is preferably rounded. The projection 6 centrally protrudes over the face 5 of the pole shoe 4.

The opposing second face 8 of the pole shoe 4 has a depression that is complementary to the projection 6.

At the height of the first face 5, the radial width of the projection 6 is smaller than the width of the first face 5. The depression 9 is also narrower than this face in the area of the second face 8. As a result, adjacent single-tooth stacks 1 abut flatly against each other not just with their projections 6 and depressions 9, but also with a portion of their faces 5, 8 (FIGS. 3 and 4). This causes the single-tooth stacks 1 inside the annular stack of laminations 2 to be flawlessly aligned relative to each other.

In the exemplary embodiment, 24 separating sites are pre-punched in the punching tool. The connecting elements provided for joining the single-tooth laminations 1a into a single-tooth stack 1 are applied or incorporated before or after the separating process. As an option, the glue dots for joining the single-tooth stacks 1 into an annular stack of laminations 2 are subsequently applied. While punching out inside the same punching tool, the exemplary 24 single-tooth laminations 1a are obtained in a circular configuration that corresponds to a plane of the annular stack of laminations 2, and joined together in the matrix of the punching sequence into the stack of laminations 2. The stack of laminations 2 is built up by the single-tooth lamination rings.

The single-tooth laminations 1a resting one on top of the other can be interconnected in any suitable manner, for example by an adhesive bond, mechanically with intermeshing elevations and depressions provided in the single-tooth laminations 1a, pins traversing through the single-tooth laminations 1a and the like. Inside the single-tooth stack 1, the projections 6 form a web that runs over the height of the single-tooth stack 1, with which the single-tooth stack 1 engages into the groove of the adjacent single-tooth stack 1 formed by the depressions 9. Since the projections 6 and depressions 9 are free of undercuts, the single-tooth stacks 1 can be easily separated before the coating and winding process, and thereafter be easily assembled by having the joining process take place in the circumferential direction of the annular stack of laminations 2 to be fabricated. The flat faces 5, 8 with which the adjacent single-tooth stacks 1 abut against each other make it possible to ensure a flawless alignment of the single-tooth stacks 1.

To prevent the annular stack of laminations 2 formed out of the single-tooth stacks from falling apart, adjacent single-tooth stacks 1 are joined together by at least one glue place. For example, the adhesive is applied to at least one end face 10 of the respectively assembled single-tooth stacks 1 in the area of the joint gap 11 between adjacent single-tooth stacks 1. Due to a capillary effect, the adhesive penetrates into the joint gap 11. The adhesive can also be applied from the opposing end face 12 of the assembled single-tooth stacks 1 in the area of the joint gap 11. Depending on the thickness of the stack of laminations 2, the adhesive can also be applied to both end faces 10, 12 in the joint gap between adjacent single-tooth stacks 1. It is also possible to apply the adhesive inside the single-tooth stack 1 to the end faces of several or all single-tooth laminations 1a.

It is likewise possible to apply the adhesive along the joint gap 11 over the length of the single-tooth stacks. However, this type of approach is only possible outside the punching process.

The adhesive causes the single-tooth stacks 1 inside the stack of laminations 2 to become adhesively bonded to each other strongly enough, so that the stack of laminations 2 does not fall apart into the single-tooth stacks 1 during transport. On the other hand, the adhesive force is only strong enough that the stack of laminations 2 can be easily divided into the individual single-tooth stacks 1 by applying a corresponding force.

In addition, the adhesive can be applied in sections onto the web formed by the projections 6, preferably as a glue dot. In like manner, the adhesive can be at least regionally applied in the groove of the single-tooth stack 1 formed by the depressions 9, preferably as a glue dot. For example a cyanoacrylate is possible as the adhesive.

Since the projections 6 and depressions 9 exhibit no undercuts, the single-tooth stacks 1 can only be detached from each other and assembled in the circumferential direction of the stack of laminations 2. In this process, the single-tooth stacks undergo absolutely no deformations that would lead to a deterioration in the electrical and/or geometric conditions.

If the single-tooth laminations 1a are cut out of the metal strip via punching, then the single-tooth laminations 1a exhibit a punch burr. It does not cause any problems while putting together the single-tooth stacks 1, since the missing undercuts make it easier to take apart the single-tooth stacks and put them back together again.

FIGS. 5 and 6 show an embodiment in which the faces 5, 8 of the pole shoes 4 of the single-tooth laminations 1a are flat. As opposed to the above embodiment, the faces 5, 8 of the single-tooth stacks 1 composed of the single-tooth laminations 1a abut flatly against each other. The faces 5, 8 lie in axial planes of the annular stack of laminations 2 composed of the single-tooth stacks 1. The adhesive is applied in the manner described, preferably as a glue dot. The adhesive is distributed over the height of the single-tooth stacks 1 when applied in such a way as to reliably hold the abutting single-tooth stacks 1 together. As in the preceding embodiment, the partial application of adhesive ensures that the single-tooth stacks 1 can be readily separated from each other again, so that they can be coated and wound.

Since the adjacent single-tooth stacks are not positively joined together, it is advantageous for the adhesive to be applied directly to the respective face 5, 8 of the single-tooth stacks 1. However, it is basically also possible to apply the adhesive to the faces 10, 12 of the abutting single-tooth stacks 1 at the height of the joint gap 11, although this could only be done outside of the punching process. The capillary action causes the adhesive to penetrate into the joint gap 11, thereby providing for a reliably strong bond between adjoining single-tooth stacks 1.

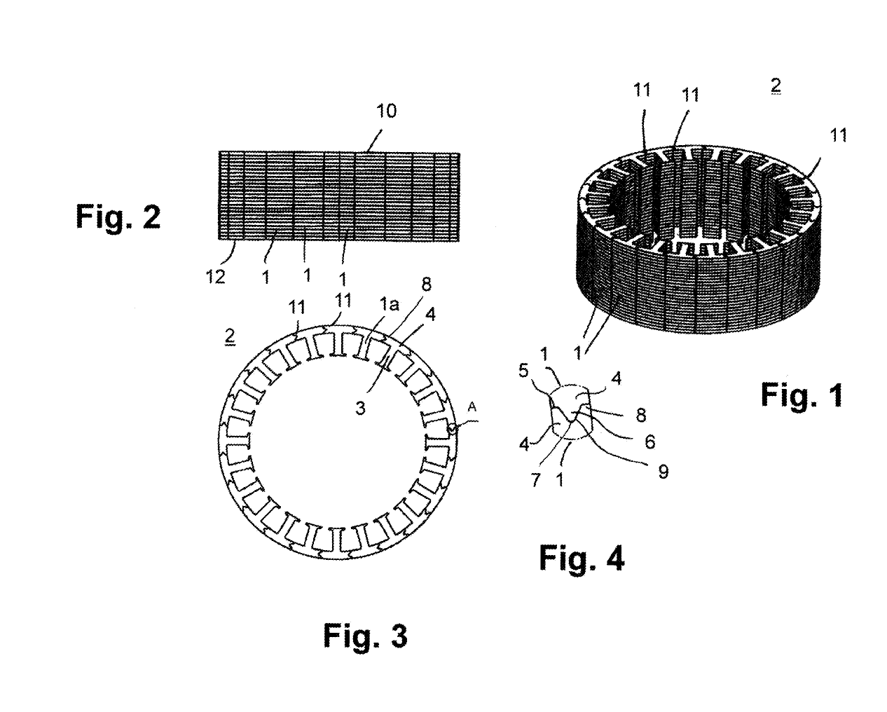

The embodiment according to FIGS. 7 and 8 essentially corresponds to the first embodiment according to FIGS. 1 to 4. The first face 5 of the pole shoe 4 is provided with the projection 6, while the second face 8 of this pole shoe exhibits the depression 9. The projection 6 is approximately semicircular in design, and narrower than the projection 6 in the embodiment according to FIGS. 1 to 4. As a result, adjacent single-tooth stacks 1 abut against each other with a larger region of their faces 5, 8. The projection 6 and depression 9 are shaped complementary to each other.

As in the previous exemplary embodiments, the circularly arranged single-tooth laminations 1a are put together into an annular stack of laminations 2. The webs of the single-tooth stacks 1 formed by the projections 6 engage into the grooves of the respectively adjacent single-tooth stack 1 formed by the recesses 9. Since the projections 6 and recesses 9 have no undercuts, the single-tooth stacks 1 can be readily detached and reassembled before coating and winding. The adhesive is again applied in such a way that the stack of laminations 2 can be divided into its individual single-tooth stacks 1 through exposure to a corresponding force. This separating process is also easily possible, since configuring the projections and depressions without undercuts makes it possible to detach the individual single-tooth stacks from each other in the circumferential direction of the stack of laminations 2.

When the single-tooth laminations la are designed approximately symmetrical to their longitudinal central plane or the single-tooth laminations lying one behind the other in the ring are rotationally symmetrical in design, a rotating station can be used to turn the stack around its axis by the angle of the single-tooth stack 1 before the punched-out single-tooth laminations 1a are placed thereon. This yields better tolerances for the lamination stack 2 in terms of its parallelism, radial run-out, axial run-out, and the like.

The specification incorporates by reference the entire disclosure of German priority document 10 2014 000 690.5 having a filing date of Jan. 17, 2014.

While specific embodiments of the invention have been shown and described in detail to illustrate the inventive principles, it will be understood that the invention may be embodied otherwise without departing from such principles.

What is claimed is:

1. An annular stack of laminations comprising single-tooth stacks adjoining each other circumferentially and each comprising at least one pole body and at least one pole shoe, wherein the at least one pole shoes each comprise a first face and a second face opposed to the first face, wherein the single-tooth stacks abut each other with the opposed first and second faces of the pole shoes, respectively, wherein the single-tooth stacks are joined together by at least one adhesive bond, wherein the at least one adhesive bond is configured to release when a force is applied so that the single-tooth stacks are detachable from the annular stack of laminations.

2. The stack of laminations according to claim 1, wherein the pole shoes each comprises at least one projection on the first face and at least one depression on the second face, wherein the projection and the depression are free of undercuts.

3. The stack of laminations according to claim 2, wherein the projection and the depression are complementary to each other.

4. The stack of laminations according to claim 2, wherein the projection has a width at the first face that is smaller than a width of the first face.

5. The stack of laminations according to claim 1 wherein an adhesive forming the at least one adhesive bond is located in a joint gap between the single-tooth stacks adjoining each other, respectively.

6. The stack of laminations according to claim 5, wherein the adhesive is applied in the form of glue dots.

7. A method for manufacturing a stack of laminations according to claim 1, wherein single-tooth stacks of single-tooth laminations are circumferentially joined to each other by first and second faces of the pole shoes that are adjoining each other, the method comprising the step of introducing an adhesive at least partially between the single-tooth stacks to form the at least one adhesive bond.

8. The method according to claim 7, further comprising applying the adhesive in a joint gap between the adjacent single-tooth stacks, respectively.

9. The method according to claim 7, further comprising applying the adhesive onto at least one end face of the stack of laminations in an area of joint gaps between the adjacent single-tooth stacks, respectively, wherein a capillary action causes the adhesive to penetrate into the joint gaps.

10. The method according to claim 7, further comprising applying the adhesive in the form of drops.

11. The method according to claim 7, further comprising producing the single-tooth laminations by fabricating, in a punching tool, separating sites between future adjacent single-tooth laminations in a first step and subsequently punching out the single-tooth laminations in a second step.

12. The method according to claim 11, wherein the single-tooth laminations are annularly arranged in a circular configuration forming a plane of the stack of laminations, wherein several of the annularly arranged single-tooth laminations forming a plane of the stack of laminations are stacked to form the stack of laminations.

13. The method according to claim 7, wherein the adhesive is applied to end faces of single-tooth laminations inside the stack of laminations.
